(19) United States
(12) Patent Application Publication
(10) Pub. No.: US 2007/0018143 A1
(43) Pub. Date: Jan. 25, 2007

(54) Flame retardant composition exhibiting superior thermal stability and flame retarding properties and use thereof

(76) Inventor: Danielle F. Goossens, Nodebais (BE)

Correspondence Address: EDGAR SPIELMAN;ALBEMARLE CORPORATION, 451 FLORIDA BLVD., BATON ROUGE, LA, 70801, US

(21) Appl. No.: 11/444,616

(22) Filed: Jun. 1, 2006

Related U.S. Application Data
(60) Provisional application No. 60/688,385, filed on Jun. 7, 2005.
(60) Provisional application No. 60/688,467, filed on Jun. 7, 2005.

(51) Int. Cl. C09K 21/00; C04B 26/12

(52) U.S. Cl. 252/609; 523/400; 524/408

(57) ABSTRACT

The present invention relates to a flame retardant composition exhibiting superior thermal stability and flame retarding properties and its use thereof.

### REFERENCE TO RELATED APPLICATION

This application claims priority to U.S. Provisional Patent Application Nos. 60/688,385 filed Jun. 7, 2005, and 60/688,467 filed Jun. 7, 2005, the disclosure of which is herein incorporated by reference in its entirety.

### SUMMARY OF THE INVENTION

The present invention relates to a flame retardant composition exhibiting superior thermal stability and flame retarding properties. More particularly, the present invention relates to a flame retardant composition and its use thereof; the flame retardant composition comprising N-2, CASE (F1)-74623-Dibromopropyl-4,5-dibromohexahydrophthalimide and a flame retarding and thermal stability improver.

### BACKGROUND OF THE INVENTION

The effectiveness of flame retarding compounds is typically attributed to two important characteristics i) flame retardancy and ii) thermal stability. The flame retardancy of a flame retarding compound is typically determined according to its Limiting Oxygen Index (“LOI”), which is generally measured according to ASTM D2863. The LOI values give the oxygen concentration of an oxygen/nitrogen mixture that only just supports the combustion of a material, and the higher the LOI value, the better the flame retarding ability of the compound.

Thermal stability is typically measured by thermogravimetric (“TGA”) analysis. This analysis involves increasing the temperature of a polymer in 10 or 20° C. increments and measuring the temperature at which a flame retardant loses a set weight percent, i.e. 5 wt. %, 10 wt. %, etc. The TGA test is a comparative test, i.e. a flame retarding compound with a higher temperature at a weight loss level when compared to another flame retarding compound at the same weight loss level is said to posses a thermal stability superior to the flame retarding compound with the lower temperature.

Generally, the polymer industry has increasingly demanded flame retarding compounds with thermal stability properties superior to those currently available that likewise impart flame retardancy to a styrenic polymer containing the compound. Thus, there is a need in the art for a flame retardant composition possessing these qualities.

### BRIEF DESCRIPTION OF THE FIGURE

The FIGURE is a graph comparing the Limiting Oxygen Index (“LOI”), i.e. flame retarding efficacy, of flame retarded polymer formulations according to the present invention.

### SUMMARY OF THE INVENTION

The present invention relates to a flame retardant composition that has enhanced thermal stability and flame retarding efficacy in extruded polystyrene foam, the composition comprising:
a) about 60 wt. % to about 95 wt. %, based on the flame retardant composition, of a N-2,3-Dibromopropyl-4,5-dibromohexahydrophthalimide;
b) about 1 wt. % to about 40 wt. %, based on the flame retardant composition, of a component (A) selected from i) natural zeolites, ii) synthetic zeolites, iii) halogenated aromatic epoxides, iv) halogenated epoxy oligomers, v) non-halogenated epoxy oligomers, vi) hydrotalcites and vii) mixtures of i)-vi); and optionally
c) a synergist selected from (i) antimony compounds; (ii) tin compounds; (iii) molybdenum compounds; (iv) zirconium compounds; (v) boron compounds; (vi) hydrotalcites; (vi) talc; (vii) dicumylperoxide; (viii) dicumyl; (ix) hindered phenolic antioxidants; (x) light stabilizers; and xi) mixtures of i)-x).

The present invention also relates to polystyrene formulations comprising flame retarding amounts of the flame retardant composition according to the present invention.

The present invention also relates to extruded polystyrene foam containing flame retarding amounts of the flame retardant composition according to the present invention.

The present invention also relates to articles produced from this flame retarded extruded polystyrene foam.

The invention also relates to a process for making a molded flame retarded extruded polystyrene product comprising blending a blowing agent, and a flame retardant composition according to the present invention to form a blended product and extruding the blended product through a die.

### DETAILED DESCRIPTION OF THE INVENTION

The present invention is a flame retardant composition comprising in the range of from about 60 wt. % to about 95 wt. %, preferably in the range of from about 90 wt. % to about 95 wt. %, N-2,3-Dibromopropyl-4,5-dibromohexahydrophthalimide, which has the formula: 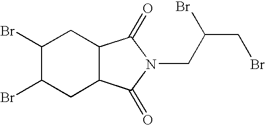
its tautomeric forms, stereo isomers, and polymorphs, referred to herein collectively as “flame retardant I”.

Flame retardant I exhibits very good solubility in polysytrene. Flame retardant I has a solubility in polysytrene of in the range of from about 0.5 to about 8 wt. %, based on the weight of the polystyrene and flame retardant I, at 20° C., and in the range of from about 0.5 to about 10 wt. %, on the same basis, at 40° C. Flame retardant I also does not deleteriously affect the formation of polystyrenic foams, which, when combined with the solubility of flame retardant I, makes flame retardant I more suitable for use in polystyrene foams than most other flame retardants.

The flame retardant composition of the present invention also comprises in the range of from about 1 wt. % to about 40 wt. % of a component (A) selected from i) natural zeolites, ii) synthetic zeolites, iii) halogenated aromatic epoxides, iv) halogenated epoxy oligomers, v) non-halogenated epoxy oligomers, vi) hydrotalcite, and vii) mixtures of i)-vii). Component A is a material that serves a dual function in the present invention. First, it serves as a thermal stabilizer for the N-2,3-Dibromopropyl-4,5-dibromohexahydrophthalimide containing flame retardant composition. Second, it also provides additional flame retardant effectiveness to the flame retardant composition. It is preferred that component A be at least one of hydrotalcite, halogenated aromatic epoxides, halogenated epoxy oligomers, non-halogenated epoxy oligomers. More preferably component A is at least one of halogenated aromatic epoxides, halogenated epoxy oligomers, non-halogenated epoxy oligomers. In more preferred embodiments, component A is selected from halogenated aromatic epoxides, halogenated epoxy oligomers, and mixtures thereof. In a most preferred embodiment, component A is a hydrotalcite.

It is preferred that component A be present in amounts in the range of from about 1 to about 25 wt. %, based on flame retardant I. In other preferred embodiments, component A is present in an amount in the range of from about 1 to about 15 wt. %, more preferably from about 3 to about 12 wt. %, based on flame retardant I.

Zeolites

Natural zeolites suitable for use herein can be selected from any known natural zeolites. Synthetic zeolites suitable for use herein can be selected from any known synthetic zeolites. Preferably the synthetic zeolite is selected from Zeoline, commercially available from Praeon, or Zeolite A, commercially available from the Albemarle Corporation under the trademark EZA. Zeolite A used in the practice of this invention can be represented by the generalized formula for zeolite, M_{2/n}OAl₂O₃ySiO₂wH₂O, wherein M is a group IA or IIA element, such as sodium, potassium, magnesium and calcium. For a sodium zeolite, the formula is Na₂OAl₂O₃xSiO₂yH₂O, wherein the value of x normally falls within the range of 1.85±0.5, and the value for y can be variant and can be any value up to about 6. On average, the value of y will be about 5.1. For a sodium Zeolite A, the formula can be written as 1.0±0.2Na₂OAlO₃1.85±0.5SiO₂yH₂O, wherein the value of y can be up to about 6. An ideal Zeolite A has the following formula, (NaAlSiO₄)₁₂ 27H₂O.

Halogenated Aromatic Epoxides

Halogenated aromatic epoxides suitable for use in the present invention are preferably diglycidyl ethers of halogenated bisphenol-A, in which about 2 to about 4 halogen atom are substituted on the bisphenol-A moiety and the halogen atoms are chlorine and/or bromine. It is more preferred that the halogen atoms on the bisphenol-A moiety be substantially all bromine atoms. Most preferably, the halogenated aromatic epoxide is selected from a brominated epoxy resin produced from TBBPA and epichlorhydran, the Praetherm™ series, preferably EP-16, commercially available from Dainippon Ink & Chemicals, and “EPIKOTE Resin-5203” fcommercially available from Resolution Performance Products.

Halogenated Aromatic Epoxy Oligomers

Halogenated aromatic epoxy oligomers suitable for use herein are halogenated bisphenol-A type epoxy resins represented by formula (I): 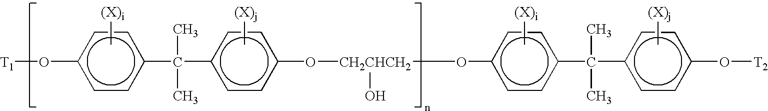
wherein X represents a halogen atom; i and j each represents an integer of from 1 to 4; n represents an average degree of polymerization in the range of 0.01 to 100, typically in the range of from 0.5 to 100, preferably in the range of from 0.5 to 50, and more preferably in the range of 0.5 to 1.5; and T₁ and T₂ are, independently and preferably: 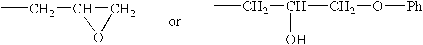
in which Ph represents a substituted or unsubstituted halogenated phenyl group, in which the ring is substituted by at least one chlorine or bromine atom. Non-limiting examples of Ph include a single or mixed isomer of bromophenyl, a single or mixed isomer of dibromophenyl, a single or mixed isomer of tribromophenyl, a single or mixed isomer of tetrabromophenyl, pentabromophenyl, a single or mixed isomer of chlorophenyl, a single or mixed isomer of dichlorophenyl, a single or mixed isomer of trichlorophenyl, a single or mixed isomer of tetrachlorophenyl, pentachlorophenyl, a single or mixed isomer of a tolyl group in which the ring is substituted by two bromine atoms, a single or mixed isomer of a tolyl group in which the ring is substituted by two chlorine atoms, and a single or mixed isomer of an ethylphenyl group in which the ring is substituted by two bromine atoms. Each halogen atom in a Ph group is preferably a bromine atom. As will be seen hereinafter, end-blocking groups other than Ph can be used.

Halogenated aromatic epoxy oligomers suitable for use herein are typically amorphous oligomeric materials, with epoxy equivalent weights above 500 g/eq, and preferably above 800 g/eq. Thus, unlike the crystalline diglycidyl ethers of tetrabromobisphenol-A with epoxy equivalent weights between 320 and 380 g/eq described in U.S. Pat. No. 6,127,558 for use in stabilizing hexabromocyclododecane, the halogenated aromatic epoxy oligomers used in the practice of this invention are highly effective even though they are not specially processed to achieve a crystalline structure, and are not characterized by such very low epoxy equivalent weights.

Non-limiting examples of one group of brominated bisphenol-A epoxy oligomers that are suitable for use herein are those compounds represented by the formula (II): 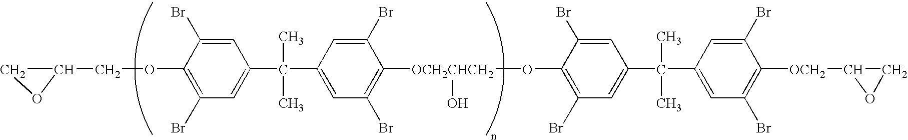
wherein n represents an average degree of polymerization in the range of from 0.5 to 100, typically in the range of from 0.5 to 50, and preferably in the range of from 0.5 to 1.5.

Non-limiting examples of commercially-available products represented by formula (II) include “F-2300”, “F-2300H”, “F-2400” and “F-2400H” from Bromokem (Far East) Ltd., “PRATHERM EP-16”, “PRATHERM EP-30”, “PRATHERM EP-100” and “PRATHERM EP-500” from Dainippon Ink & Chemicals, Incorporated, “SR-T1000”, “SR-T2000”, “SR-T5000” and “SR-T20000” from Sakamoto Yakuhin Kogyo Co., Ltd., and “EPIKOTE Resin-5112” from Resolution Performance Products.

Brominated bisphenol-A epoxy oligomers wherein the epoxy group at each end of the resin has been blocked with a blocking agent, and resins wherein only the epoxy group at one end has been blocked with a blocking agent, are also suitable for use as the halogenated aromatic epoxy oligomers herein. Non-limiting examples of suitable blocking agents include those blocking agents permitting the ring-opening addition of the epoxy group such as phenols, alcohols, carboxylic acids, amines, isocyanates and the like, each containing a bromine atom. Among them, brominated phenols are preferred for improving flame retarding effects. Examples thereof can include dibromophenol, tribromophenol, pentabromophenol, dibromoethylphenol, dibromopropylphenol, dibromobutylphenol, dibromocresol and the like.

Examples of brominated bisphenol-A epoxy oligomers in which epoxy groups at both ends thereof are blocked with a blocking agent, can be represented by formulas (III) and (IV): 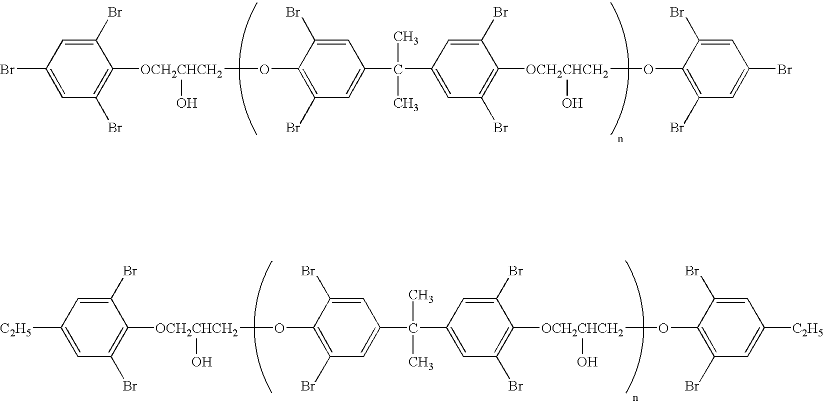
wherein n represents an average degree of polymerization in the range of from 0.5 to 100, typically in the range of from 0.5 to 50, and preferably in the range of from 0.5 to 1.5.

Non-limiting examples of commercially-available products of formula (III) or (IV) include “PRATHERM EC-14”, “PRATHERM EC-20” and “PRATHERM EC-30” from Dainippon Ink & Chemicals, Incorporated, “TB-60” and “TB-62” from Tohto Chemical Co., Ltd., “SR-T3040” and “SR-T7040” from Sakamoto Yakuhin Kogyo Co., Ltd., and “EPIKOTE Resin-5203” from Resolution Performance Products.

Brominated bisphenol-A epoxy oligomers in which the polymer has a blocking agent at one end can be represented by formulas (V) and (VI): 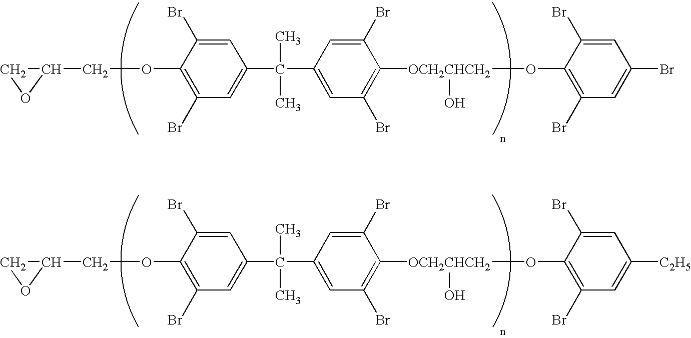
wherein n represents an average degree of polymerization in the range of from 0.5 to 100, typically in the range of from 0.5 to 50, and preferably in the range of from 0.5 to 1.5.

Non-limiting examples of commercially-available products of formula (V) or (VI) include “PRATHERM EPC-15F” from Dainippon Ink & Chemicals, Incorporated, and “E5354” from Yuka Shell Epoxy Kabushiki Kaisha.

Non-Halogenated Aromatic Epoxy Oligomers

Non-halogenated epoxy oligomers suitable for use herein can take the form of any of those having formulas (I)-(VI) above. However, in the non-halogenated epoxy oligomers, the halogen component is replaced by a hydrogen atom. For example, bisphenol-A epoxy oligomers are suitable for use herein as a Non-halogenated epoxy oligomer. Non-limiting examples of non-halogenated epoxy oligomers suitable for use herein include any available epoxy resin produced from bisphenol A and epichlorohydrin.

Hydrotalcites

Hydrotalcites suitable for use herein include both natural and synthetic hydrotalcites. Generally, hydrotalcites suitable for use in the present invention include those represented by the general formula:
M²⁺₁₋ₓM³⁺(OH)₂(Aⁿ⁻)_{x/n}mH₂0
wherein M²⁺ is selected from the group consisting of Mg²⁺, Ca²⁺, Sr²⁺, Ba²⁺, Zn²⁺, Cd²⁺, Pb²⁺, Sn²⁺, or Ni²⁺; and M³⁺ is selected from Al³⁺, B³⁺; or Bi³⁺; Aⁿ⁻ is an anion having valence of n, preferably selected from the group consisting of OH⁻, Cl⁻, Br⁻, I⁻, ClO₄⁻, HCO₃⁻, CH₃COO⁻, C₆H₅COO⁻, CO₃⁻², SO₄⁻², (COO⁻)₂, (CHOH)₄CH₂OHCOO⁻, C₂H₄(COO)₂⁻², (CH₂COO)₂⁻², CH₃CHOHCO⁻, SiO₃⁻², SiO₄⁻⁴, Fe(CN)₆⁻³, Fe(CN)₆⁻⁴ or HPO₄⁻²; n is a number in the range of from about 1 to about 4; x is a number in the range of from about 0 to about 0.5; and m is a number in the range of from about 0 to about 2. Preferably, M²⁺ is Mg²⁺ or a solid solution of Mg and Zn, M³⁺ is Al³⁺; Aⁿ⁻ is CO₃⁻² or SO₄⁻², x is a number in the range of from 0 to 0.5, and m is a positive value.

Exemplary hydrotalcites include, but are not necessarily limited to: Al₂O₃.6MgO.CO₂.12H₂O; Mg_{4.5}Al₂(OH)₁₃.CO₃.3.5H₂O; 4MgO.Al₂O₃.CO₂.6H₂O; ZnO₃MgO.Al₂O₃.CO₂.wH₂O, wherein w is in the range of 8-9, and ZnO.3MgO.Al₂O₃.CO₂.wH₂O, wherein w is in the range of 5-6.

Some empirical formulas provided by a commercial supplier of several preferred hydrotalcites include Mg_{4.5}Al₂(OH)₁₃.CO₃, Mg_{4.5}Al₂(OH)₁₃.CO₃.3H₂O, Mg_{4.5}Al₂(OH)₁₃.CO₃.3.5H₂O, and Mg_{4.5}Al₂(OH)₁₃.O₀₂.(CO₃)_{0.8}.

Hydrotalcites having the above general formulas are readily available commercially. Some common suppliers of such hydrotalcites include Kyowa Chemical Industry Co., Ltd, which supplies hydrotalcites under the trade designations ALCAMIZER, DHT-4A, DHT-4C and DHT-4V; and J. M. Huber Corporation, which supplies hydrotalcites under the trade designations under the trade designations Hysafe 539 and Hysafe 530. In a particularly preferred embodiment of the present invention, the hydrotalcite used herein is one available from Kyowa Chemical Industry Co., Ltd, particularly preferred is the DHT-4A hydrotalcite.

As stated above, in a preferred embodiment, component A is a hydrotalcite. In this embodiment, the hydrotalcite is present in an amount in the range of from about 1 to about 25 wt. %, based on the weight of the flame retardant composition. Preferably, the hydrotalcite is present in an amount in the range of from about 1 to about 15 wt. %, on the same basis, more preferably the hydrotalcite is present in an amount in the range of from about 1 to about 10 wt. %, most preferably in the range of from about 2 to about 6 wt. %, on the same basis.

Extruded Polystyrene Foam

In another embodiment, the present invention is a flame retarded polymer formulation comprising greater than about 50 wt% extruded polystyrene foam, based on the weight of the flame retarded polymer formulation, and a flame retarding amount of a flame retardant composition according to the present invention. Preferably the flame retarded polymer comprises greater than about 75 wt. %, based on the weight of the flame retarded polymer formulation, extruded polystyrene, and more preferably in the range of from about 90 wt. % to about 99.5 wt. % extruded polystyrene foam, on the same basis.

The flame retardant composition of the present invention is especially well suited for use in extruded polystyrene foams. Non-limiting examples of uses of these foams include thermal insulation. Extruded polystyrene foams suitable for use herein can be prepared by any processes known in the art, and one such process involves forming the expanded polystyrene foam from a vinyl aromatic monomer having the formula:
H₂C═CR−Ar;
wherein R is hydrogen or an alkyl group having from 1 to 4 carbon atoms and Ar is an aromatic group (including various alkyl and halo ring substituted aromatic units) having from about 6 to about 10 carbon atoms, for example, a styrenic polymer. Non-limiting examples of such vinyl aromatic monomers include styerene, alpha-methylstyrene, ortho-methylstyrene, meta-methylstyrene, para-methylstyrene, para-ethylstyrene, isopropylpenttoluene, isopropylnaphthalene, vinyl toluene, vinyl naphthalene, vinyl biphenyl, vinyl anthracene, the dimethylstyrenes, t-butylstyrene, the several chlorostyrenes (such as the mono- and di-chloro variants, and the several bromostyrenes (such as the mono-, dibromo- and tribromo variants). Non-limiting examples of uses of these foams include thermal insulation.

According to one aspect of the present invention, the monomer is styrene. Polystyrene is prepared readily by bulk or mass, solution, suspension, or emulsion polymerization techniques known in the art. Polymerization can be affected in the presence of free radical cationic or anionic initiators. Non-limiting examples of suitable initiators include di-t-butyl peroxide, azeo-bis(isobutyronitrile), di-benzoyl peroxide, t-butyl perbenzoate, dicumyl peroxide, potassium persulfate, aluminum trichloride, boron trifluoride, etherate complexes, titanium tetrachloride, n-butyllithium, t-butyllithium, cumyl potassium, 1,3-trilithiocyclohexane, and the like. Additional details of the polmerization of styrene, alone or in the presence of one or more monomers copolymerizable with styrene, are well known in the art.

The polystyrene used in the present invention typically has a molecular weight of at least about 1,000. In some embodiments, the polysytrene has a molecular weight of at least about 50,000. In other embodiments, the polystyrene has a molecular weight ranging from about 150,000 to about 500,000. However, it should be noted that the polystyrene having a higher molecular weight may be used where suitable or desired.

Flame Retardant Composition

As stated above, the flame retarded polymer formulations of the present invention comprise a flame retarding amount of a flame retardant composition according to the present invention. By a flame retarding amount, it is generally meant that amount sufficient to provide test specimens that can achieve a UL 94 test rating of at least V-2 with ⅛-inch thick specimens or a DIN 4102 test of at least B2 for a 10 mm thick specimen (for EPS and XPS). In most cases a flame retarding amount will be that amount sufficient to provide a total halogen content that falls in the range of from about 0.3 to about 10 wt %, and preferably in the range of from about 0.5 to about 6 wt%, based on the weight of the flame retarded polymer formulation. Generally, this amount is in the range of from about 0.01 wt. % to about 50wt% of the flame retardant composition, based on the weight of the flame retarded polymer formulation, preferably in the range of from about 0.01 wt. % to about 25 wt. %, on the same basis, and more preferably in the range of from about 0.5 wt. % to about 7 wt. %, on the same basis. In a most preferred embodiment, a flame retarding amount is in the range of from about 1 wt. % to about 5 wt. % of the flame retardant composition, on the same basis. In some embodiments, however, a flame retarding amount is in the range of from about 3 wt. % to about 4 wt. % of the flame retardant composition, on the same basis

Flame Retarded Polymer Formulation

The flame retardant polymer formulations of the present invention can be formed by any process or method known. An exemplary procedure involves melting a polystyrene resin in an extruder. The molten resin is the transferred to a mixer, for example a rotary mixer having a studded rotor encased within a housing with a studded internal surface that intermeshes with the studs on the rotor. The molten resin and a volatile foaming or blowing agent are fed into the inlet end of the mixer and discharged from the outlet end as a gel, the flow being in a generally axial direction. From the mixer, the gel is passed through coolers, and the cooled gel is then passed through a die that extrudes a generally rectangular board. Non-limiting examples of procedures suitable for forming the extruded polystyrene foams suitable for use in the present invention can be found in United U.S. Pat. Nos. 5,011,866; 3,704,083; and 5,011,866, all of which are incorporated herein by reference in their entirety. Other examples of suitable processes can be found in U.S. Pat. Nos. 2,450,436; 2,669,751; 2,740,157; 2,769,804; 3,072,584; and 3,215,647, all of which are incorporated herein by reference in their entirety.

Any of a wide variety of known foaming agents, which are sometimes referred to as blowing agents, can be used in producing the extruded polystyrene foams of the present invention. Non-limiting examples of suitable foaming agents can be found in U.S. Pat. No. 3,960,792, which is incorporated herein by reference in its entirety. Generally speaking, volatile carbon-containing chemical substances are the most widely for this purpose. They include, for example, such materials as aliphatic hydrocarbons including ethane, ethylene, propane, propylene, butane, butylene, isobutane, pentane, neopentane, isopentane, hexane, heptane and mixtures thereof; volatile halocarbons and/or halohydrocarbons, such as methyl chloride, chlorofluoromethane, bromochlorodifluoromethane, 1,1,1-trifluoroethane, 1,1,1,2-tetrafluoroethane, dichlorofluoromethane, dichlorodifluoromethane, chlorotrifluoromethane, trichlorofluoromethane, sym-tetrachlorodifluoroethane, 1,2,2-trichloro-1,1,2-trifluoroethane, sym-dichlorotetrafluoroethane; volatile tetraalkylsilanes, such as tetramethylsilane, ethyltrimethylsilane, isopropyltrimethylsilane, and n-propyltrimethylsilane; and mixtures of such materials. One preferred fluorine-containing blowing agent is 1,1-difluoroethane also known as HFC-152a (FORMACEL Z-2, E. I. duPont de Nemours and Co.) because of its reported desirable ecological properties. Water-containing vegetable matter such as finely-divided corn cob can also be used as blowing agents. As described in U.S. Pat. No. 4,559,367, such vegetable matter can also serve as fillers. Carbon dioxide may be used a foaming agent, or at least a component of the foaming agent. Non-limiting examples of methods for using carbon dioxide as a blowing agent are described in U.S. Pat. Nos. 5,006,566; 5,189,071; 5,189,072; and 5,380,767, which are all incorporated herein by reference in their entirety. Non-limiting examples of other suitable blowing agents include nitrogen, argon, and water with or without carbon dioxide. If desired, such blowing agents or blowing agent mixtures can be mixed with alcohols, hydrocarbons, or ethers of suitable volatility, see, for example, U.S. Pat. No. 6,420,442, which is incorporated herein by reference in its entirety.

Synergist

Although the flame retardant composition of the present invention is suitable for use in most applications, in some applications it may be desired to further increase its flame retardant efficacy. In this regard, the flame retardant composition can optionally include any flame retardant synergist known in the art, and thus when the flame retardant composition is used in a flame retardant polymer formulation the flame retardant polymer formulation would also comprise the optional synergist. Non-limiting examples of suitable flame-retardant synergists include (i) antimony compounds such as antimony trioxide, antimony tetroxide, antimony pentoxide, and sodium antimonate; (ii) tin compounds such as tin oxide and tin hydroxide; (iii) molybdenum compounds such as molybdenum oxide and ammonium molybdenum; (iv) zirconium compounds such as zirconium oxide and zirconium hydroxide; (v) boron compounds such as zinc borate and barium metaborate; (vi) dicumylperoxide; and (vii) dicumyl. Other components that may be used as flame retardant synergists include talc, hindered phenolic antioxidants, and light stabilizers. The proportions of the optional flame retardant synergist relative to the N-2,3-Dibromopropyl-4,5-dibromohexahydrophthalimide component are conventional and can be varied to suit the needs of any given situation.

The ratio of the synergist to the total amount of flame retardant I is typically in the range of about 1:1 to about 1:7. Preferably, the synergist is used in a ratio in the range of about 1:2 to about 1:4.

In preferred embodiments, the flame retardant composition comprises the optional synergist. In a particularly preferred embodiment, the flame retardant composition comprises at least dicumyl as an optional synergist. In some embodiments, the flame retardant composition comprises only dicumyl as the synergist. The inventor hereof has discovered that the use of dicumyl as a synergist, particularly when hydrotalcite is present, provides for Limiting Oxygen Index results superior to other combinations and other synergists alone. While not wishing to be bound by theory, the inventor hereof attributes this to unexpected synergistic effects, in particular unexpected synergistic effects achieved by using a combination of dicumyl and hydrotalcite, preferably synthetic hydrotalcites, more preferably DHT-4A.

Generally, the synergist may be present in an amount in the range of from about 0.01 to about 5 wt. %, based on the weight of flame retardant composition. Preferably, the synergist is present in an amount in the range of from about 0.05 to about 3 wt. %, on the same basis, and more preferably the synergist is present in an amount in the range of from about 0.1 to about 1 wt. %, on the same basis. In a most preferred embodiment, the synergist is present in an amount in the range of from about 0.1 to about 0.5 wt. %, on the same basis.

Other Optional Additives

Non-limiting examples of other additives that are suitable for use in the flame retardant composition and flame retarded polymer formulations of the present invention include extrusion aids such as barium stearate or calcium stearate, organoperoxides, dyes, pigments, fillers, thermal stabilizers, antioxidants, antistatic agents, reinforcing agents, metal scavengers or deactivators, impact modifiers, processing aids, mold release aids, lubricants, anti-blocking agents, other flame retardants, UV stabilizers, plasticizers, flow aids, and the like. If desired, nucleating agents such as calcium silicate or indigo can be included in the flame retarded polymer formulations also. The proportions of the other optional additives are conventional and can be varied to suit the needs of any given situation.

The method by which the various components, both optional and otherwise, of the flame retarded polymer formulations are formulated with the polystyrene prior to being extruded is not critical to the present invention and suitable techniques, methods, or processes are known. For example, the flame retardant composition may be incorporated into the extruded polystyrenic foam by wet or dry techniques. Non-limiting examples of dry techniques include those wherein the flame retardant composition is mixed with pellets of the extruded polystyrenic foam, and this mixture is then extruded under elevated temperatures sufficient to cause the expanded polystyrenic foam to melt. Non-limiting examples of wet methods include mixing a solution of the flame retardant composition with molten resin of the extruded polystyrenic foam. Still further, the flame retarded polymer formulations can be prepared by use of conventional blending equipment such as a twin-screw extruder, a Brabender mixer, or similar apparatus. It is also possible to separately add the individual components of the flame retarded polymer formulations of this invention to the extruded polystyrenic foam. Preferably, however, a preformed flame retardant composition of the present invention is blended with the extruded polystyrenic foam.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. For example, the amount of synergist, can also include amounts in the range of about 0.5 to about 3 wt. %, 0.05 to about 1 wt. %, 3 to about 5 wt. %, etc. The following examples will illustrate the present invention, but are not meant to be limiting in any manner.

### EXAMPLES

### Example 1

N-2,3-Dibromopropyl-4,5-dibromohexahydrophthalimide, flame retardant I, referred to as “FR” in this and the following Examples, was blended with 5 wt. % or 10 wt. %, based on the weight of FR, of various known thermal stability improvers to form flame retardant compositions. Some of these flame retardant compositions were those according to the present invention, e.g. EP-16, Zeolite A, and non-brominated epoxy oligomer, and some were not according to the present invention. The thermal stability of the flame retardant compositions was then measured via dynamic thermogravimetric (“TGA”) analysis. The thermal stability of the flame retardant compositions according to the present invention were then compared to the thermal stability of the flame retardant compositions not according to the present invention. The results of the TGA measurements are contained in Table 1 below.

EP-16 as used herein refers to a brominated bisphenol-A epoxy resin marketed by Dainippon Ink & Chemicals, Incorporated. DGETBBPA refers to diglycidyl ether of tetrabromodisphenol A, and TSPP refers to tetra sodium polyphosphate. DBTM refers to dibutyl tin maleate and DHT 4A refers to hydrotalcite marketed by Mipsui. The non-d epoxy oligomer (“non Br EO”) is sold by Aldrich as catalog number 40545-0.

To perform the TGA tests, approximately (10) micrograms of the flame retardant on was placed in a 70 microliter alumina crucible without a lid. The crucible was placed in a 100% nitrogen atmosphere, and the temperature of the crucible was increased in increments of 10° C./minute from an initial temperature of 30° C. until a final temperature of 750° C. was reached. The temperature at which the various flame retardant compositions lost a set percent of their weight, as indicated in Table 1, was measured and recorded.

TABLE 1

| | | FR + | FR + | FR + 5 | FR + 5 | FR + 5 | FR + 5 | FR + 10 |
|---|---|---|---|---|---|---|---|---|
| | | 5 wt. % | 5 wt. % | wt. % | wt. % | wt. % | wt. % | wt. % non- |
| wt. loss | FR | EP-16 | DGETBBP | TSPP | DBTM | DHT 4A | Zeolite A | Br EO |
| percent | (T° C.) | (T° C.) | A (T° C.) | (T° C.) | (T° C.) | (T° C.) | (T° C.) | (T° C.) |
| 1 | 210.40 | 223.76 | 227.81 | 227.63 | 199.20 | 205.72 | 223.63 | 231.58 |
| 5 | 224.54 | 233.72 | 234.79 | 242.31 | 224.28 | 227.43 | 250.86 | 248.23 |
| 10 | 234.67 | 241.65 | 241.25 | 250.25 | 231.15 | 232.96 | 256.19 | 255.89 |
| 20 | 246.28 | 252.08 | 250.51 | 258.81 | 239.95 | 240.22 | 264.35 | 262.94 |
| 50 | 264.70 | 269.87 | 267.90 | 277.85 | 256.56 | 252.51 | 277.65 | 277.01 |

As can be seen in Table 1, flame retardant compositions containing DBTM and DHT 4A (hydrotalcite), both well-known thermal stabilizers, unexpectedly do not show any thermal stability improvement over that of the FR. However, the flame retardant compositions containing DGETPPA, EP-16, TSPP, non-brominated epoxy oligomers, and Zeolite A do show improvements in thermal stability over FR.

### Example 2

In this example, as illustrated in Table 2 below, FR was blended with either 2.5 wt. % or 5 wt. % of a halogenated aromatic epoxy oligomer (EP-16) and either 2.5 wt. % or 5 wt. % of a hydrotalcite (DHT-4A), all weight percents based on the weight of FR, to test the effect of various levels of hydrotalcite and halogenated aromatic epoxy oligomer on the TGA analysis of a flame retardant composition according to the present invention.

To perform the TGA tests, approximately (10) micrograms of the flame retardant composition was placed in a 70 microliter alumina crucible without a lid. The crucible was placed in a 100% nitrogen atmosphere, and the temperature of the crucible was increased in increments of 10° C./minute from an initial temperature of 30° C. until a final temperature of 750° C. was reached. The temperature at which the various flame retardant compositions lost a set percent of their weight, as indicated in Table 1, was measured and recorded.

TABLE 2

| | | FR + | FR + 2.5% |
|---|---|---|---|
| Wt. | FR | 5% EP16 + | EP16 + |
| loss | Pure | 5% DHT-4A | 2.5% DHT-4A |
| % | (T° C.) | (T° C.) | (T° C.) |
| 1% | 210.40 | 205.93 | 220.90 |
| 5% | 224.54 | 244.37 | 245.20 |
| 10% | 234.67 | 252.17 | 253.14 |
| 20% | 246.28 | 258.98 | 260.79 |
| 50% | 264.70 | 275.93 | 273.64 |

As can be seen in Table 2, the 5 wt. % of halogenated aromatic epoxy oligomer and 5 wt. % of hydrotalcite provides for a flame retardant composition with improved thermal stability when compared to the FR only. However, the inventors hereof have unexpectedly discovered that lower levels, i.e. 2.5 wt. %, of the halogenated aromatic epoxy oligomer and hydrotalcite provides for a flame retardant composition with improved thermal stability when compared to the FR only and also compared to the flame retardant composition comprising 5 wt. % of the halogenated aromatic epoxy oligomer and hydrotalcite.

### Example 3

The flame retardancy of various flame retarded polymer formulations according to the present invention was then analyzed. The flame retardancy of the flame retarded polymer formulations was determined according to its Limiting Oxygen Index (“LOI”), which was measured according to ASTM D2863. The LOI values give the oxygen concentration of an oxygen/nitrogen mixture that just barely supports the combustion of a material. The higher the LOI value, the better the flame retarding ability of the flame retarded polymer formulations.

The content of the various flame retarded polymer formulations tested are shown in Tables 2 and 3 below along with the LOI of that flame retarded polymer formulation. These flame retarded polymer formulations were formed by combining a styrenic polymer obtained from Dow Chemical Corporation and marketed under the name Styron 678E, a styrenic polymer commonly used in polystyrene foam applications, with the flame retardant compositions of Example 1.

Also, as comparative flame retarded polymer formulations, HP900, a flame retardant composition available commercially from the Albemarle Corporation, was blended with Styron 678E and also with 5 wt. % TSPP and Styron 678E.

TABLE 3

| | | | | | | HP900 + | |
|---|---|---|---|---|---|---|---|
| Component | | | | FR + 10 wt. % | FR + 10 wt. % | 5 wt. % | FR + 5 wt. % |
| (wt. %) | No FR | FR Only | HP900 | EP-16 | TSPP | TSPP | Non Br EO |
| Styron 678E | 100.000 | 96.300 | 97.000 | 95.930 | 95.930 | 96.850 | 96.115 |
| FR | | 3.700 | | 3.700 | 3.700 | | 3.700 |
| HP900 | | | 3.000 | | | 3.000 | |
| EP-16 | | | | 0.370 | | | |
| TSPP | | | | | 0.370 | 0.150 | |
| Zeolite-A | | | | | | | |
| Non Br EO | | | | | | | 0.185 |
| DHT-4A | | | | | | | |
| LOI (% O2) | 18.200 | 23.700 | 24.600 | 25.800 | 22.500 | 24.800 | 25.000 |

TABLE 4

| | FR + 10 wt % | FR + 5 wt % | FR + 10 wt % | FR + 5 wt % | FR + 10 wt % |
|---|---|---|---|---|---|
| Component | Non Br EO | DHT-4A | DHT-4A | Zeolite-A | Zeolite-A |
| Styron 678E | 95.930 | 96.115 | 95.930 | 96.115 | 95.930 |
| FR | 3.700 | 3.700 | 3.700 | 3.700 | 3.700 |
| HP900 | | | | | |
| EP-16 | | | | | |
| TSPP | | | | | |
| Zeolite-A | | | | 0.185 | 0.370 |
| Non Br EO | 0.370 | | | | |
| DHT-4A | | 0.185 | 0.370 | | |
| LOI (% O2) | 24.900 | 25.500 | 25.700 | 24.100 | 23.900 |

As can be seen in Table 2, Table 3, and the FIGURE, when the flame retarded polymer formulation contains FR along with EP-16, Zeolite A, or non-brominated epoxy oligomer, (flame retardant compositions according to the present invention) the flame retardancy of the flame retarded polymer formulation is improved. Also, the thermal stability of the flame retardant composition is likewise improved, as illustrated in Table 1.

TSPP is a known thermal stability/flame retardancy improver. For example, when the flame retarded polymer formulation contains HP900 as the flame retardant composition and 5 wt. % TSPP, the flame retardancy is improved over the flame retarded polymer formulation containing the Styron 678E and HP900 only. However, very unexpectedly, when the flame retarded polymer formulation contains a flame retardant composition containing TSPP and FR, the FR-containing flame retarded polymer formulations demonstrate a flame retardancy less than the FR only formulation, i.e. TSPP has an antagonistic effect on the flame retardancy properties of FR. However, the flame retardant composition containing TSPP and FR demonstrates an improvement in thermal stability, as indicated in Table 1. Thus, illustrating that it is unexpected that only certain known thermal stabilizers/flame retardant improvers are suitable for improving both the flame retardancy and thermal stability of FR.

DHT 4A (hydrotalcite) is also a known thermal stability/flame retardancy improver. Thus, it is unexpected that the flame retarded polymer formulations containing a FR/DHT 4A (hydrotalcite) flame retardant composition demonstrate an improvement in flame retardancy, but the flame retardant composition shows a decreased thermal stability, as indicated in Table 1. Again illustrating that it is unexpected that only certain known thermal stabilizers/flame retardant improvers are suitable for improving both the flame retardancy and thermal stability of FR.

Thus, the inventor hereof has discovered that only certain materials commonly used as flame retardancy/thermal stabilizer improvers can be used to improve both the thermal stability of flame retardant compounds containing the N-2,3-Dibromopropyl-4,5-dibromohexahydrophthalimide flame retardant, while at the same time improving the thermal stability of flame retardant polymer formulations containing the flame retardant composition. Likewise, the inventor hereof has unexpectedly demonstrated that some of the more commonly used flame retardancy/thermal stabilizer improvers such as hydrotalcite (DHT 4A) or TSPP do not provide for this benefit, and in some instances are detrimental to the desired properties, i.e. thermal stability and/or flame retardancy.

### Example 4

In this example, the effect of varying concentrations of hydrotalcite, dicumyl, and the combination of the two, on the flame retardancy of various flame retarded polymer formulations according to the present invention was analyzed. The flame retardancy of the flame retarded polymer formulations was again determined according to its Limiting Oxygen Index (“LOI”), which was measured according to ASTM D2863.

The content of the various flame retarded polymer formulations tested are shown in Table 5, below, along with the LOI of that flame retarded polymer formulation. These flame retarded polymer formulations were formed by combining a styrenic polymer obtained from Dow Chemical Corporation and marketed under the name Styron 680, a styrenic polymer commonly used in polystyrene foam applications, with CCDFB Dicumyl, the commercial name for Dicumyl—( 2,3-Dimethyl, 2,3-DiPhenyl Butane CAS# 1889-67-4) sold by Peroxid Chemie GMBH, and a hydrotaclite, DHT-4A.

It should be noted that all component amounts in Table 5 are represented in weight percents based on the total weight of the flame retarded polymer formulations.

TABLE 5

| | Formulation Number | | | | | |
|---|---|---|---|---|---|---|
| | 1163 | 1164 | 1165 | 1166 | 1167 | 1168 |
| Styron 680 | 96.29 | 96.19 | 96.09 | 95.89 | 95.99 | 95.89 |
| FR | 3.71 | 3.71 | 3.71 | 3.71 | 3.71 | 3.71 |
| DHT-4A | | 0.1 | 0.2 | 0.2 | 0.3 | 0.4 |
| CCDFB | | | | 0.2 | | |
| L.O.I | 25.6 | 26.6 | 26.1 | 27.6 | 25.4 | 25 |

As demonstrated in Table 5, as the amount of hydrotalcite in the flame retarded polymer formulation increases, the LOI of the flame retarded polymer formulations begins to increase, but then decreases. In fact, when the level increases above 0.3 wt. %, the LOI of the flame retarded polymer formulation is actually worse than the LOI of a flame retarded polymer formulation containing the FR alone. Thus, the inventor hereof has discovered that there is a preferred amount of hydrotalcite.

Further, the inventor hereof has discovered that the combination of the hydrotalcite and dicumyl provides for an LOI improvement over the FR alone and also over the flame retarded polymer formulation containing the same amount of hydrotalcite. The inventor hereof attributes this improvement to a synergistic effect between the hydrotalcite and dicumyl.

What is claimed:

1. A flame retardant composition that has enhanced thermal stability and flame retarding efficacy in extruded polystyrene foam comprising:
a) in the range of from about 60 wt. % to about 95 wt. %, based on the flame retardant composition, of flame retardant I;
b) in the range of from about 1 wt. % to about 40 wt. %, based on the flame retardant composition, of a component (A) selected from i) natural zeolites, ii) synthetic zeolites, iii) halogenated aromatic epoxides, iv) halogenated epoxy oligomers, v) non-halogenated epoxy oligomers, vi) hydrotalcites and vii) mixtures of i)-vi); and optionally,
c) a synergist selected from (i) antimony compounds; (ii) tin compounds; (iii) molybdenum compounds; (iv) zirconium compounds; (v) boron compounds; (vi) hydrotalcites; (vi) talc; (vii) dicumylperoxide; (viii) dicumyl; (ix) hindered phenolic antioxidants; (x) light stabilizers; and xi) mixtures of i)-x).

2. The flame retardant composition according to claim 1 wherein component (A) is an epoxy compound selected from halogenated aromatic epoxides represented by formula (I): 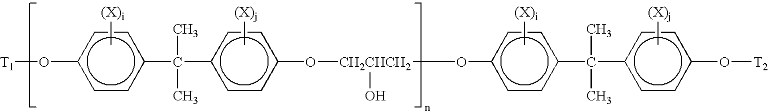
wherein X represents, independently, a chlorine or bromine atom, i and j each represents an integer of from 1 to 4; n represents an average degree of polymerization in the range of 0.01 to 100; and T₁, and T₂ are, independently selected from: 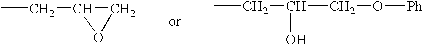
in which Ph represents a substituted or unsubstituted halogenated phenyl group, and in which the ring is substituted by at least one chlorine or bromine atom.

3. The flame retardant composition according to claim 2 wherein said halogenated aromatic epoxides is selected from diglycidyl ethers of halogenated bisphenol-A, in which about 2 to about 4 halogen atom are substituted on the bisphenol-A moiety and the halogen atoms are chlorine, bromine, and mixtures thereof.

4. The flame retardant composition according to claim 3 wherein the halogen atoms are substantially all bromine atoms.

5. The flame retardant composition according to claim 1 wherein component (A) is an epoxy compound selected from halogenated epoxy oligomers.

6. The flame retardant composition according to claim 5 wherein said halogenated epoxy oligomer is at least one of:
a) a brominated bisphenol-A epoxy resin represented by formula (II): 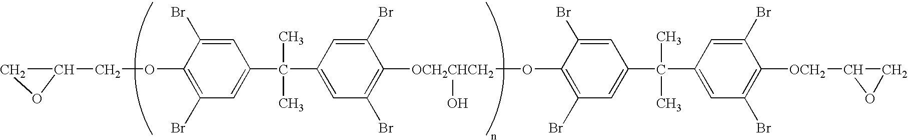
wherein n represents an average degree of polymerization in the range of from 0.5 to 100.
b) a halogenated epoxy oligomer represented by formula (III): 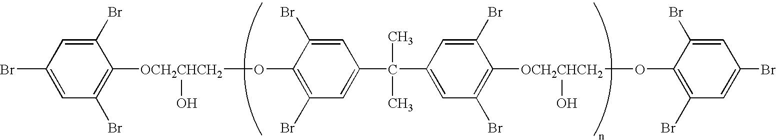
wherein n represents an average degree of polymerization in the range of from 0.5 to 100.
c) a halogenated epoxy oligomer represented by formula (IV): 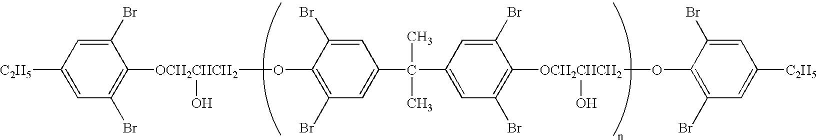
wherein n represents an average degree of polymerization in the range of from 0.5 to 100.
d) a brominated bisphenol-A epoxy resin in which the polymer has a blocking agent at one end and is represented by formula (V): 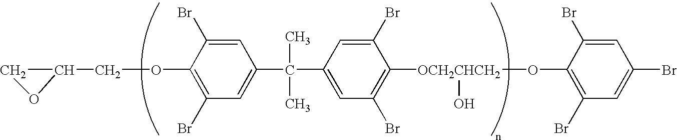
wherein n represents an average degree of polymerization in the range of 0.5 to 100.
e) a brominated bisphenol-A epoxy resin in which the polymer has a blocking agent at one end and is represented by formula (VI): 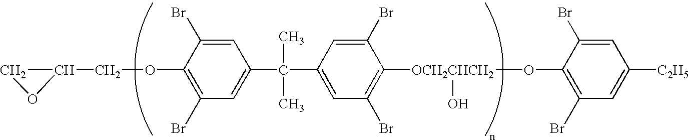
wherein n represents an average degree of polymerization in the range of from 0.5 to 100.

7. The flame retardant composition according to any of claims 2 or 6 wherein the (i) antimony compounds are selected from antimony trioxide, antimony tetroxide, antimony pentoxide, and sodium antimonate; the (ii) tin compounds are selected from tin oxide and tin hydroxide; (iii) the molybdenum compounds are selected from molybdenum oxide and ammonium molybdenum; the (iv) zirconium compounds are selected from zirconium oxide and zirconium hydroxide; and the (v) boron compounds are selected from zinc borate and barium metaborate.

8. The flame retardant composition according to claim 1 wherein component (A) is a natural or synthetic zeolite.

9. The flame retardant composition according to claim 1 wherein component (A) is a non-halogenated epoxy oligomer.

10. The flame retardant composition according to claim 8 wherein said synthetic zeolite is selected from Zeoline and Zeolite A.

11. The flame retardant composition according to claim 9 wherein said non-halogenated epoxy oligomer is selected from those having the formula (I) through (VI) wherein the Br atoms of formulas (I) through (VI) have been replaced by hydrogen atoms.

12. The flame retardant composition according to any of claims 1, 2, or 6 wherein said flame retardant composition includes said synergist.

13. The flame retardant composition according to claim 12 wherein said synergist is dicumyl.

14. The flame retardant composition according to claim 1 wherein component A is selected from a) hydrotalcite, b) brominated bisphenol-A epoxy resins represented by formula (II), and c) mixtures thereof.

15. The flame retardant composition according to claim 13 wherein component A is selected from a) hydrotalcite, b) brominated bisphenol-A epoxy resins represented by formula (II), and c) mixtures thereof.

16. The flame retardant composition according to claim 12 wherein said synergist is present in an amount in the range of from about 0.01 to about 5 wt. %, based on the weight of the flame retardant composition.

17. The flame retardant composition according to claim 13 wherein said synergist is present in an amount in the range of from about 0.1 to about 0.5 wt. %, based on the weight the flame retardant composition.

18. The flame retardant composition according to claim 16 wherein the ratio of the synergist to the total amount of flame retardant I is in the range of about 1:1 to about 1:7.

19. The flame retardant composition according to claim 17 wherein the ratio of the synergist to the total amount of flame retardant I is in the range of about 1:2 to about 1:4.

20. The flame retardant composition according to claim 12 wherein component A is present in an amount in the range of from about 1 to about 25 wt. %, based on the weight of the flame retardant composition.

21. The flame retardant composition according to claim 12 wherein component A is present in an amount in the range of from about 1 to about 15 wt. %, based on the weight of the flame retardant composition.

22. The flame retardant composition according to claim 17 wherein component A is hydrotaclite and component A is present in an amount in the range of from about 2 to about 6 wt. %, based on the weight of the flame retardant composition.

23. A flame retarded polymer formulation comprising:
a) greater than about 50wt % extruded polystyrene foam, based on the weight of the flame retarded polymer formulation; and
b) a flame retarding amount of a flame retardant composition comprising:
i) in the range of from about 60 wt. % to about 95 wt. %, based on the flame retardant composition, of a N-2,3-Dibromopropyl-4,5-dibromohexahydrophthalimide;
ii) in the range of from about 1 wt. % to about 40 wt. %, based on the flame retardant composition, of a component (A) selected from i) natural zeolites, ii) synthetic zeolites, iii) halogenated aromatic epoxides, iv) halogenated epoxy oligomers, v) non-halogenated epoxy oligomers, vi) hydrotalcites and vii) mixtures of i)-vi); and optionally,
iii) a synergist selected from (i) antimony compounds; (ii) tin compounds; (iii) molybdenum compounds; (iv) zirconium compounds; (v) boron compounds; (vi) hydrotalcites; (vi) talc; (vii) dicumylperoxide; (viii) dicumyl; (ix) hindered phenolic antioxidants; (x) light stabilizers; and xi) mixtures of i)-x).

24. The flame retarded polymer formulation according to claim 23 wherein said flame retarded polymer formulation comprises greater than about 75 wt. %, based on the weight of the flame retarded polymer formulation, extruded polystyrene foam.

25. The flame retarded polymer formulation according to claim 23 wherein said flame retarded polymer formulation comprises from about 90 wt. % to about 99.5 wt. % extruded polystyrene foam, based on the weight of the flame retarded polymer formulation.

26. The flame retarded polymer formulation according to claim 23 wherein said flame retarding amount is that amount of flame retardant composition sufficient to provide test specimens of the flame retardant polymer formulations that can achieve a UL 94 test rating of at least V-2 with ⅛-inch thick specimens or a DIN 4102 test of at least B2 for a 10 mm thick specimen (for EPS and XPS).

27. The flame retarded polymer formulation according to claim 23 wherein said flame retarding amount is that amount necessary to provide a total halogen content of the flame retarded polymer formulation in the range of from about 0.3 to about 10 wt %, based on the weight of the flame retarded polymer formulation.

28. The flame retarded polymer formulation according to claim 23 wherein said flame retarding amount is in the range of from about 0.01 wt. % to about 50 wt. %, based on the weight of the flame retarded polymer formulation.

29. The flame retarded polymer formulation according to claim 24 wherein said flame retarding amount is in the range of from about 0.01 wt. % to about 25 wt. %, based on the weight of the flame retarded polymer formulation.

30. The flame retarded polymer formulation according to claim 24 wherein said flame retarding amount is from about 0.5 wt. % to about 7 wt. %, based on the weight of the flame retarded polymer formulation.

31. The flame retarded polymer formulation according to claim 23 wherein said flame retarded polymer formulation further comprises extrusion aids such as barium stearate or calcium sterate, organoperoxides, dyes, pigments, fillers, thermal stabilizers, antioxidants, antistatic agents, reinforcing agents, metal scavengers or deactivators, impact modifiers, processing aids, mold release aids, lubricants, anti-blocking agents, other flame retardants, UV stabilizers, plasticizers, flow aids, nucleating agents such as calcium silicate or indigo, and the like.

32. The flame retarded polymer formulation according to claim 30 wherein component (A) of said flame retardant composition is an epoxy compound selected from halogenated aromatic epoxides represented by formula (I): 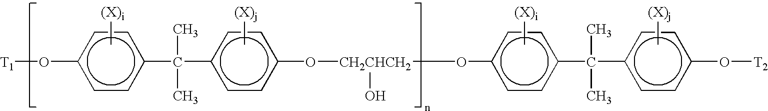
wherein X represents, independently, a chlorine or bromine atom, i and j each represents an integer of from 1 to 4; n represents an average degree of polymerization in the range of 0.01 to 100; and T₁, and T₂ are, independently selected from: 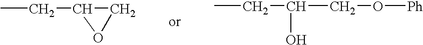
in which Ph represents a substituted or unsubstituted halogenated phenyl group, and in which the ring is substituted by at least one chlorine or bromine atom.

33. The flame retarded polymer formulation according to claim 32 wherein said halogenated aromatic epoxides is selected from diglycidyl ethers of halogenated bisphenol-A, in which about 2 to about 4 halogen atom are substituted on the bisphenol-A moiety and the halogen atoms are chlorine, bromine, and mixtures thereof.

34. The flame retarded polymer formulation according to claim 23 wherein component (A) is an epoxy compound selected from halogenated epoxy oligomers, said halogenated epoxy oligomers selected from at least one of:
a) a brominated bisphenol-A epoxy resin represented by formula (II): 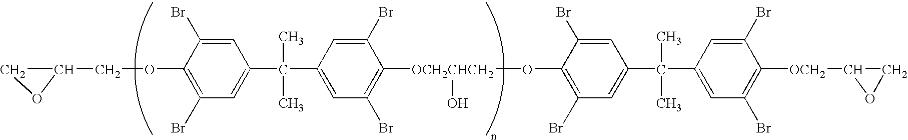
wherein n represents an average degree of polymerization in the range of from 0.5 to 100.
b) a halogenated epoxy oligomer represented by formula (III): 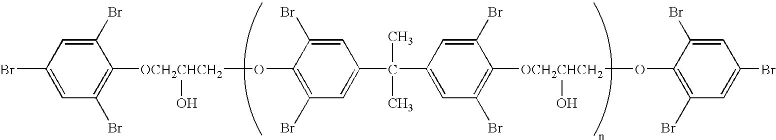
wherein n represents an average degree of polymerization in the range of from 0.5 to 100.
c) a halogenated epoxy oligomer represented by formula (IV): 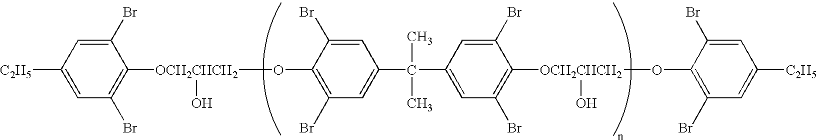
wherein n represents an average degree of polymerization in the range of from 0.5 to 100.
d) a brominated bisphenol-A epoxy resin in which the polymer has a blocking agent at one end and is represented by formula (V): 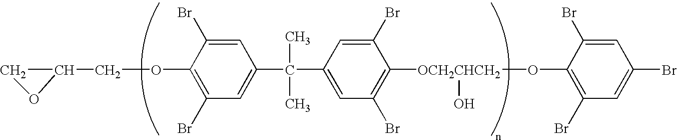
wherein n represents an average degree of polymerization in the range of 0.5 to 100.
e) a brominated bisphenol-A epoxy resin in which the polymer has a blocking agent at one end and is represented by formula (VI): 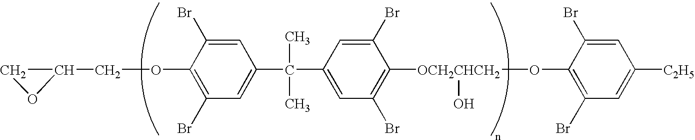
wherein n represents an average degree of polymerization in the range of from 0.5 to 100.

35. The flame retarded polymer formulation according to claim 23 wherein component (A) is a natural or synthetic zeolite or a non-halogenated epoxy oligomer.

36. The flame retarded polymer formulation according to claim 34 wherein said non-halogenated epoxy oligomer is selected from those having the formula (I) through (VI) wherein the Br atoms of formulas (I) through (VI) have been replaced by hydrogen atoms.

37. The flame retarded polymer formulation according to any of claims 23, 32, or 34 wherein said flame retardant composition includes said synergist.

38. The flame retardant composition according to claim 37 wherein said synergist is dicumyl.

39. The flame retardant composition according to claim 37 wherein component A is selected from a) hydrotalcite, b) brominated bisphenol-A epoxy resins represented by formula (II), and c) mixtures thereof, wherein component A is present in an amount in the range of from about 1 to about 25 wt. %, based on the weight of the flame retardant composition.

40. The flame retardant composition according to claim 38 wherein component A is selected from a) hydrotalcite, b) brominated bisphenol-A epoxy resins represented by formula (II), and c) mixtures thereof, wherein component A is present in an amount in the range of from about 1 to about 15 wt. %, based on the weight of the flame retardant composition.

41. The flame retardant composition according to claim 37 wherein said synergist is present in an amount in the range of from about 0.01 to about 5 wt. %, based on the weight of the flame retardant composition I.

42. The flame retardant composition according to claim 40 wherein said synergist is present in an amount in the range of from about 0.1 to about 0.5 wt. %, based on the weight of the flame retardant composition.

43. The flame retardant composition according to claim 37 wherein component A is hydrotaclite and component A is present in an amount in the range of from about 2 to about 6 wt. %, based on the weight of the flame retardant composition.

44. The flame retardant composition according to claim 38 wherein component A is hydrotaclite and component A is present in an amount in the range of from about 2 to about 6 wt. %, based on the weight of the flame retardant composition.

45. A process for making a molded flame retarded extruded polystyrene product comprising blending polystyrene, a blowing agent, and a flame retardant composition according to the present invention to form a blended product and extruding the blended product through a die, wherein said flame retardant composition comprises:
a) in the range of from about 60 wt. % to about 95 wt. %, based on the flame retardant composition, of N-2,3-Dibromopropyl-4,5-dibromohexahydrophthal imide; and
b) in the range of from about 1 wt. % to about 40 wt. %, based on the flame retardant composition, of a component (A) selected from i) natural zeolites, ii) synthetic zeolites, iii) halogenated aromatic epoxides, iv) halogenated epoxy oligomers, v) non-halogenated epoxy oligomers, vi) hydrotalcites and vii) mixtures of i)-vi); and optionally,
c) a synergist selected from (i) antimony compounds; (ii) tin compounds; (iii) molybdenum compounds; (iv) zirconium compounds; (v) boron compounds; (vi) hydrotalcites; (vi) talc; (vii) dicumylperoxide; (viii) dicumyl; (ix) hindered phenolic antioxidants; (x) light stabilizers; and xi) mixtures of i)-x).

46. The process according to claim 45 wherein an extrusion aids such as barium stearate or calcium sterate, organoperoxides, dyes, pigments, fillers, thermal stabilizers, antioxidants, antistatic agents, reinforcing agents, metal scavengers or deactivators, impact modifiers, processing aids, mold release aids, lubricants, anti-blocking agents, other flame retardants, UV stabilizers, plasticizers, flow aids, nucleating agents such as calcium silicate or indigo, and the like is also used in producing said blended product.

47. The process according to claim 45 wherein component (A) of said flame retardant composition is an epoxy compound selected from halogenated aromatic epoxides represented by formula (I): 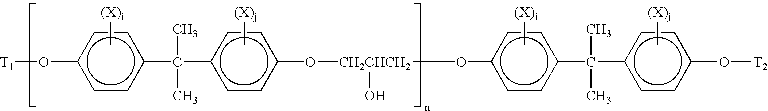
wherein X represents, independently, a chlorine or bromine atom, i and j each represents an integer of from 1 to 4; n represents an average degree of polymerization in the range of 0.01 to 100; and T₁, and T₂ are, independently selected from: 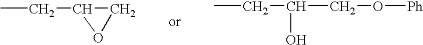
in which Ph represents a substituted or unsubstituted halogenated phenyl group, and in which the ring is substituted by at least one chlorine or bromine atom.

48. The process according to claim 47 wherein said halogenated aromatic epoxides is selected from diglycidyl ethers of halogenated bisphenol-A, in which about 2 to about 4 halogen atom are substituted on the bisphenol-A moiety and the halogen atoms are chlorine, bromine, and mixtures thereof.

49. The process according to claim 45 wherein component (A) is an epoxy compound selected from halogenated epoxy oligomers, said halogenated epoxy oligomers selected from at least one of:
a) a brominated bisphenol-A epoxy resin represented by formula (II): 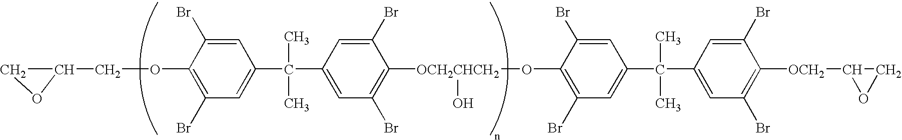
wherein n represents an average degree of polymerization in the range of from 0.5 to 100.
b) a halogenated epoxy oligomer represented by formula (III): 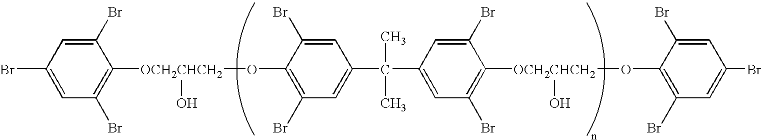
wherein n represents an average degree of polymerization in the range of from 0.5 to 100.
c) a halogenated epoxy oligomer represented by formula (IV): 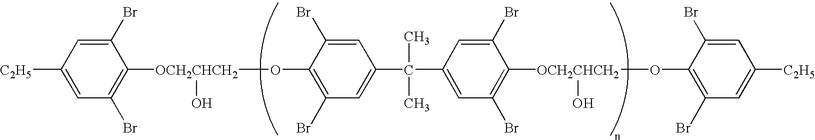
wherein n represents an average degree of polymerization in the range of from 0.5 to 100.
d) a brominated bisphenol-A epoxy resin in which the polymer has a blocking agent at one end and is represented by formula (V): 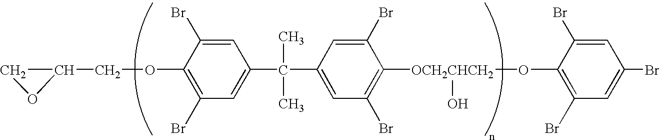
wherein n represents an average degree of polymerization in the range of 0.5 to 100.
e) a brominated bisphenol-A epoxy resin in which the polymer has a blocking agent at one end and is represented by formula (VI): 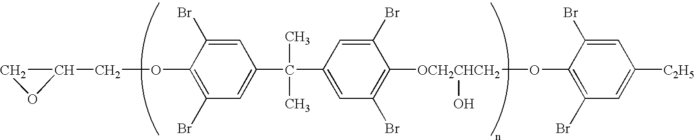
wherein n represents an average degree of polymerization in the range of from 0.5 to 100.

50. The process according to claim 45 wherein component (A) is a natural or synthetic zeolite or a non-halogenated epoxy oligomer.

51. The process according to claim 49 wherein said non-halogenated epoxy oligomer is selected from those having the formula (I) through (VI) wherein the Br atoms of formulas (I) through (VI) have been replaced by hydrogen atoms.

52. The process according to any of claims 45, 47 or 49 wherein said flame retardant composition includes said synergist.

53. The process according to claim 52 wherein said synergist is dicumyl.

54. The process according to claim 52 wherein component A is selected from a) hydrotalcite, b) brominated bisphenol-A epoxy resins represented by formula (II), and c) mixtures thereof, wherein component A is present in an amount in the range of from about 1 to about 25 wt. %, based on the weight of flame retardant.

55. The process according to claim 53 wherein component A is selected from a) hydrotalcite, b) brominated bisphenol-A epoxy resins represented by formula (II), and c) mixtures thereof, wherein component A is present in an amount in the range of from about 1 to about 15 wt. %, based on the weight of flame retardant.
